(19) United States
(12) Patent Application Publication
(10) Pub. No.: US 2024/0284473 A1
(43) Pub. Date: Aug. 22, 2024

(54) UTILIZING BITS OF WAVEFORM DEPENDENT DCI FIELDS INTRODUCED BY DYNAMIC WAVEFORM SWITCHING

(71) Applicant: Nokia Technologies Oy, Espoo (FI)

(72) Inventors: Amir Mehdi AHMADIAN TEHRANI, Munich (DE); Nhat-Quang NHAN, Massy (FR); Marco MASO, Massy (FR); Alessio MARCONE, Munich (DE); Karim KASAN, Nozay (FR); Majed SAAD, Massy (FR)

(21) Appl. No.: 18/426,871

(22) Filed: Jan. 30, 2024

Related U.S. Application Data
(60) Provisional application No. 63/485,881, filed on Feb. 17, 2023.

(51) Int. Cl. H04W 72/231; H04W 72/0453; H04W 72/1268

(52) U.S. Cl. CPC H04W 72/231; H04W 72/0453; H04W 72/1268

(57) ABSTRACT

A method in comprises determining, at an apparatus, a feature of at least one feature according to a list of at least one list causing transmission, at the apparatus, of a UL transmission according to the feature. The determining based on a number of bits (N), the at least one list of at least one waveform dependent field, one or more bits of at least one waveform dependent field of downlink control information (DCI) for scheduling an uplink (UL) transmission, an indication that dynamic waveform switching (DWS) is utilized of the downlink control information (DCI) for scheduling the uplink (UL) transmission, and a waveform indicated by the downlink control information (DCI) for scheduling an uplink (UL) transmission.

### RELATED APPLICATION

This application claims priority to, and benefit of, U.S. Provisional Application No. 63/485,881, filed on Feb. 17, 2023, the contents of which is incorporated herein by reference in its entirety.

### TECHNICAL FIELD

Various example embodiments relate to wireless communications.

### BACKGROUND

Communication systems are under constant development. The 5G, 5G-Advanced, and beyond future wireless networks aim to support a large variety of services with increasing demand in terms of data rate and throughput while providing a higher degree of reliability, keeping the overall system complexity affordable. One factor affecting how the aims are achieved is a waveform that will be used in an air interface. There exists a plurality of different waveforms. However, none of them is an optimal waveform for all use case scenarios.

### SUMMARY

Various aspects of examples of the invention are set out in the claims.

According to a first aspect, there is described a method comprising: determining, at an apparatus, a feature of at least one feature according to a list of at least one list based on: a number of bits, the at least one list of at least one waveform dependent field, one or more bits of at least one waveform dependent field of downlink control information for scheduling an uplink transmission, an indication that dynamic waveform switching is utilized of the downlink control information for scheduling the uplink transmission, and a waveform indicated by the downlink control information for scheduling an uplink transmission, and causing transmission, at the apparatus, of an uplink transmission according to the feature.

According to a second aspect, there is described an apparatus comprising: at least one processor; and at least one memory storing instructions that, when executed by the at least one processor, are configured to cause the apparatus at least to perform a plurality of operations, the plurality of operations comprising: determining a feature of at least one feature according to a list of at least one list based on: a number of bits, the at least one list of at least one waveform dependent field, one or more bits of at least one waveform dependent field of downlink control information for scheduling an uplink transmission, an indication that dynamic waveform switching is utilized of the downlink control information for scheduling the uplink transmission, and a waveform indicated by the downlink control information for scheduling an uplink transmission; and causing transmission of an uplink transmission according to the feature.

According to a third aspect, there is described and apparatus comprising: at least one processor; and at least one memory storing instructions that, when executed by the at least one processor, are configured to cause the apparatus at least to perform a plurality of operations, the plurality of operations comprising: causing transmission of a downlink control information for scheduling an uplink transmission, wherein the downlink control information for scheduling the uplink transmission comprises an indication that dynamic waveform switching is utilized, an indication that indicates a waveform and information according to one or more bits of at least one waveform dependent field of the downlink control information for scheduling information;
receiving an uplink transmission according to a feature of at least one feature, and determining a feature of the at least one feature according to a list of at least one list based on: a number of bits, at least one list of at least one waveform dependent field, one or more bits of the at least one waveform dependent field of downlink control information for scheduling the uplink transmission, the indication that dynamic waveform switching (DWS) is utilized of the downlink control information (DCI) for scheduling the uplink (UL) transmission, and the waveform indicated by the downlink control information (DCI) for scheduling an uplink (UL) transmission.

### BRIEF DESCRIPTION OF DRAWINGS

Embodiments are described below, by way of example only, with reference to the accompanying drawings, in which

FIG. 1 illustrates an exemplified wireless communication system;

FIG. 2 illustrates an exemplified information exchange;

FIGS. 3 to 7 are flow charts illustrating example functionalities; and

FIGS. 8 to 10 are schematic block diagrams.

### DETAILED DESCRIPTION OF SOME EMBODIMENTS

The following embodiments are only presented as examples. Although the specification may refer to “an”, “one”, or “some” embodiment(s) and/or example(s) in several locations, this does not necessarily mean that each such reference is to the same embodiment(s) or example(s), or that a particular feature only applies to a single embodiment and/or single example. Single features of different embodiments and/or examples may also be combined to provide other embodiments and/or examples. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first predefined purpose could be termed a second predefined purpose, and similarly, a second predefined purpose could be also termed a first predefined purpose without departing from the scope of the present disclosure.

In the following, different exemplifying embodiments will be described using, as an example of an access architecture to which the embodiments may be applied, a radio access architecture based on long term evolution advanced (LTE Advanced, LTE-A) or new radio (NR, 5G, 5G-Advanced), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

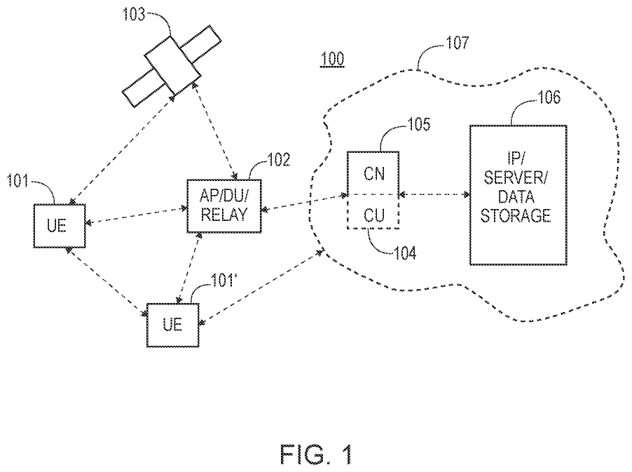

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system 100 given as an example but a person skilled in the art may apply the solution to other communication systems provided with necessary properties.

The example of FIG. 1 shows a part of an exemplifying radio access network.

FIG. 1 shows user devices 101, 101′ configured to be in a wireless connection on one or more communication channels in a cell with an access node (such as (e/g)NodeB) providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), or user plane function (UPF), or access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a computing device (e.g. a portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction, e.g., to be used in smart power grids and connected vehicles. The user device may also utilize cloud. In some applications, a user device may comprise a user portable device with radio parts (such as a watch, earphones, eyeglasses, other wearable accessories or wearables) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses. Further, it should be appreciated that a number of reception and/or transmission antennas in a user device may vary according to implementation and/or type of the user device.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilize services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

Edge cloud may be brought into a radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real-time functions being carried out at the RAN side (in a distributed unit, DU 102) and non-real-time functions being carried out in a centralized manner (in a central unit, CU 104). Another example of distribution, the open RAN, includes also disaggregation of certain functionalities between a distributed unit and one or more radio units (illustrated as one entity, DU&RU 102).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

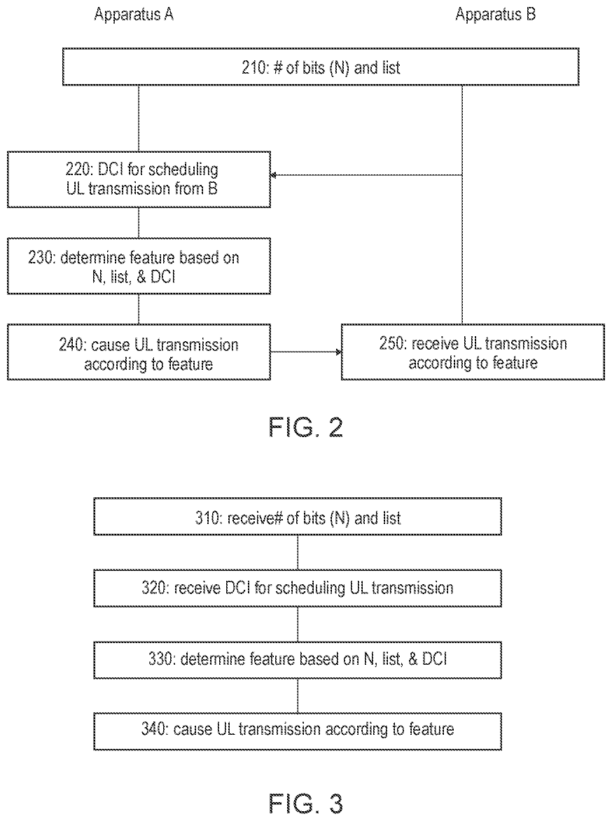

5G networks, 5G-Advanced networks and it is envisaged that 6G networks and beyond, support two or more different waveforms for uplink transmissions. For example, the 5G-Advanced network may semi-statically configure, as a part of radio resource control configuration of an apparatus, for example, a waveform for uplink transmissions. Since the waveform semi-statically configured may not be an optimal waveform for a specific scenario, it is envisaged that a waveform may be dynamically determined (selected) based on an indication provided by repurposed one or more bits in downlink control information, for example as illustrated with FIGS. 2 to 8. A repurposed bit, or a set of repurposed bits means that the bit, or the set of bits, may be used at least to a first purpose or a second purpose. The first purpose may be a legacy purpose, e.g. a purpose for which the bit or set of bits are used in 5G network or earlier generation networks, and, depending on a scenario, the second purpose, which may be called a repurpose, is for another purpose, or for an additional purpose, to indicate at least a waveform to be used. The term “bit” used herein covers any information unit transmitted in control signaling to which unit a value, that may be different from 1 and 0 and that may be formed by a set of values, may be determined. For example, assuming that a bit space for a process field in a downlink controlling information is 4 bits, meaning that the process field may be used to indicate one out of up to 16 processes, the set of values indicating e.g. 12 processes, or 6, or 5, just to give couple of non-limiting examples, as a first purpose, may be an information unit indicating a first waveform as a second purpose, and the set of values indicating the remaining 4, or 6, or 11 processes as a first purpose, may be an information unit indicating a second waveform as a second purpose. The information unit may be called a signaling state. It should be appreciated that the different examples and solutions discussed herein with uplink transmissions may be implement with downlink transmissions as well.

FIG. 2 illustrates exemplified information exchanges between different apparatuses in a radio network configured to support utilization of bits of waveform dependent DCI fields introduced by dynamic waveform switching.

For the sake of clarity of the description, only two apparatuses that may communicate over an air interface are illustrated, one of them, “apparatus A”, at least receiving uplink transmissions and transmitting downlink, the other apparatus, “apparatus B”, at least receiving downlink transmissions and transmitting uplink, without limiting the example to such a solution and apparatuses. The apparatus A may be, for example, an access point or a distributed unit, or any corresponding unit, examples of which are listed above with reference to block 102 in FIG. 1. The apparatus B may be, for example, a user equipment, including wearables, vehicles, robotics, etc., further examples of which are listed above with reference to blocks 101, 101′ in FIG. 1.

FIG. 2 illustrates exemplified information exchanges between different apparatuses in a radio network configured to support utilization of bits of waveform dependent DCI fields introduced by dynamic waveform switching. For the sake of clarity of the description, only two apparatuses that may communicate over an air interface are illustrated, one of them, “apparatus B”, at least receiving uplink transmissions and transmitting downlink, the other apparatus, “apparatus A”, at least receiving downlink transmissions and transmitting uplink, without limiting the example to such a solution and apparatuses. The apparatus B may be, for example, an access point or a distributed unit, or any corresponding unit, examples of which are listed above with reference to block 102 in FIG. 1. The apparatus A may be, for example, a user equipment, including wearables, vehicles, robotics, etc., further examples of which are listed above with reference to blocks 101, 101′ in FIG. 1.

In the examples illustrated in FIG. 2, both apparatuses are provided (block 210) with a number of bits (N) and at least one list. Depending on an implementation, at least some of the number of bits and the at least one list may be hardcoded to the apparatuses and/or the apparatus B may have determined these or some of these, or received these, or some of these, for example from a central unit, and then configured the apparatus A, for example using radio resource control configuration, or radio resource control reconfiguration, or a higher-layer configuration, for example as part of a physical uplink shared channel configuration, or in one or more information elements in a search space configuration. The at least one list comprises at least one waveform dependent field. The at least one list and the number of bits in conjunction with other information disclosed herein are used to determine the utilization of bits of waveform dependent DCI fields introduced by dynamic waveform switching. However, the details how the apparatuses A and B are provided with the number of bits and the at least one list are not relevant for describing how they are used, and hence, there is no need to describe the details herein.

Referring to FIG. 2, when the apparatus A receives (220) downlink control information for scheduling information, for example as response for the apparatus B having requested resources for uplink data transmission, the apparatus A determines (block 230) a feature of at least one feature according to a list of at least one list based on the number of bits (N), the at least one list of at least one waveform dependent field, one or more bits of at least one waveform dependent field of downlink control information (DCI) for scheduling an uplink (UL) transmission, an indication that dynamic waveform switching (DWS) is utilized of the downlink control information (DCI) for scheduling the uplink (UL) transmission, and a waveform indicated by the downlink control information (DCI) for scheduling an uplink (UL) transmission. Thereby the apparatus A knows the feature that is to be utilized for transmission from the apparatus B.

The apparatus A then causes transmission (block 240) of a UL transmission according to the feature.

The apparatus B receives transmission (block 250) of a UL transmission according to the feature.

FIGS. 3 to 7 illustrate some non-limiting examples of how the feature according to which the UL transmission is transmitted is determined. The examples are described using principles and terminology of 5G-Advanced technology without limiting the examples to 5G-Advanced, and the terminology used. In particular, an issue with applying zero-padding for DCI size alignment in dynamic waveform switching is that, the zero-padded bits always exist in the DCI (regardless of the indicated waveform) even if they are not needed for the indicated waveform. Specifically, when switching from CP-OFDM to DFT-s-OFDM, the zero-padded bits are totally wasted decreasing the performance (and coverage) of the PDCCH carrying the DCI. A larger number of information bits requires indeed a larger SNR at the receiver for a certain target BLER.

Given that, positions of these zero-padded bits are known to the UE thanks to the waveform information indicated by scheduling DCI (especially in case the bits are padded at the end/beginning of each waveform dependent field), they can be leveraged for other uses.

FIGS. 3 to 7 illustrate some non-limiting examples of how the feature according to which the UL transmission is transmitted is determined. FIG. 3 is a flow chart illustrating example functionalities of apparatus A configured to support utilization of bits of waveform dependent DCI fields introduced by dynamic waveform switching. FIG. 3 illustrates example functionalities of apparatus A that may communicate over an air interface, at least receiving downlink transmissions and transmitting uplink, without limiting the example to such a solution and apparatuses. The apparatus A may be, for example, a user equipment, including wearables, vehicles, robotics, etc., further examples of which are listed above with reference to blocks 101, 101′ in FIG. 1.

In the example illustrated in FIG. 3, apparatus A is provided (block 310) with a number of bits (N) and at least one list. The at least one list comprises at least one waveform dependent field. The at least one list and the number of bits in conjunction with other information disclosed herein are used to determine the utilization of bits of waveform dependent DCI fields introduced by dynamic waveform switching. However, the details how the apparatus A is provided with the number of bits and the at least one list are not relevant for describing how they are used, and hence, there is no need to describe the details herein.

Referring to FIG. 3, when the apparatus A receives (320) downlink control information for scheduling information, for example as response for having requested resources for uplink data transmission, the apparatus A determines (block 330) a feature of at least one feature according to a list of at least one list based on the number of bits (N), the at least one list of at least one waveform dependent field, one or more bits of at least one waveform dependent field of downlink control information (DCI) for scheduling an uplink (UL) transmission, an indication that dynamic waveform switching (DWS) is utilized of the downlink control information (DCI) for scheduling the uplink (UL) transmission, and a waveform indicated by the downlink control information (DCI) for scheduling an uplink (UL) transmission. Thereby the apparatus A knows the feature that is to be utilized for transmission from the apparatus B.

The apparatus A then causes transmission (block 340) of a UL transmission according to the feature.

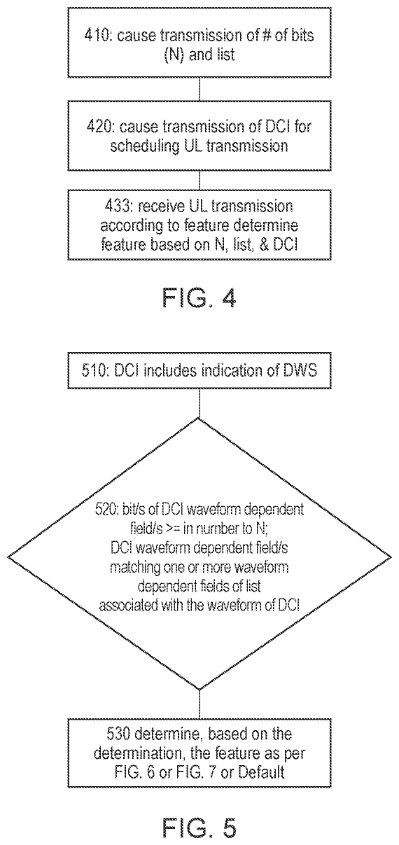

FIG. 4 is a flow chart illustrating example functionalities of apparatus B configured to support utilization of bits of waveform dependent DCI fields introduced by dynamic waveform switching. FIG. 4 illustrates example functionalities of apparatus B that may communicate over an air interface, at least receiving uplink transmissions and transmitting downlink, without limiting the example to such a solution and apparatuses. The apparatus B may be, for example, an access point or a distributed unit, or any corresponding unit, examples of which are listed above with reference to block 102 in FIG. 1.

In the examples illustrated in FIG. 4, apparatuses B is provided with a number of bits (N) and at least one list. Depending on an implementation, at least some of the number of bits and the at least one list may be hardcoded to the apparatuses and/or the apparatus B may have determined these or some of these, or received these, or some of these, for example from a central unit. Apparatus B causes transmission (block 410) of the number of bits and the at least one list to apparatus A so as to configure apparatus A, for example via or using radio resource control configuration, or radio resource control reconfiguration, or a higher-layer configuration, for example as part of a physical uplink shared channel configuration, or in one or more information elements in a search space configuration. The at least one list comprises at least one waveform dependent field. The at least one list and the number of bits in conjunction with other information disclosed herein are used to determine the utilization of bits of waveform dependent DCI fields introduced by dynamic waveform switching. However, the details how the apparatuses A and B are provided with the number of bits and the at least one list are not relevant for describing how they are used, and hence, there is no need to describe the details herein.

Referring to FIG. 4, the apparatus B causes transmission (block 420) of downlink control information (DCI) for scheduling information, for example, as response for the apparatus A having requested resources for uplink data transmission. The DCI for scheduling information comprises an indication that dynamic waveform switching (DWS) is utilized and an indication that indicates a waveform. The DCI for scheduling information also comprises information according to one or more bits of at least one waveform dependent field of DCI for scheduling information.

The apparatus B receives (block 430) a UL transmission according to a feature of at least one feature. The feature of at least one feature is determined based on the number of bits (N), the at least one list of at least one waveform dependent field, one or more bits of at least one waveform dependent field of the downlink control information (DCI) for scheduling an uplink (UL) transmission, the indication that dynamic waveform switching (DWS) is utilized of the downlink control information (DCI) for scheduling the uplink (UL) transmission, and a waveform indicated by the downlink control information (DCI) for scheduling an uplink (UL) transmission.

FIG. 5 is a flow chart illustrating example functionalities of apparatus A configured to support utilization of bits of waveform dependent DCI fields introduced by dynamic waveform switching. FIG. 5 illustrates example functionalities of apparatus A that determining a feature of at least one feature according to a list of at least one list, where the apparatus A causes transmission of a UL transmission according to the feature.

Referring to FIG. 5, apparatus A determines (block 510) that the indication that dynamic waveform switching (DWS) is utilized is included in the downlink control information (DCI) for scheduling the uplink (UL) transmission.

Apparatus A (block 520) makes a determination whether the one or more bits of at least one waveform dependent field of the downlink control information (DCI) for scheduling the uplink (UL) transmission are greater than or equal in number to the number of bits (N), wherein the at least one waveform dependent field of the downlink control information (DCI) match one or more of the at least one waveform dependent field of the list of the at least one list, the list being associated with the waveform indicated by the downlink control information (DCI) for scheduling the uplink (UL) transmission.

Apparatus A (block 530) determines, based on the determination, the feature of the at least one feature based on indication information indicated by the one or more bits of the at least one waveform dependent field of the downlink control information (DCI) for scheduling the uplink (UL) transmission.

In one embodiment, determining evaluates the list is evaluated in a sequential order to determine the at least one waveform dependent field of the downlink control information (DCI) matching one or more of the at least one waveform dependent field of the list of the at least one list. In one embodiment, the sequential order begins with one of the following: a first waveform dependent field of the list; and a last waveform dependent field of the list.

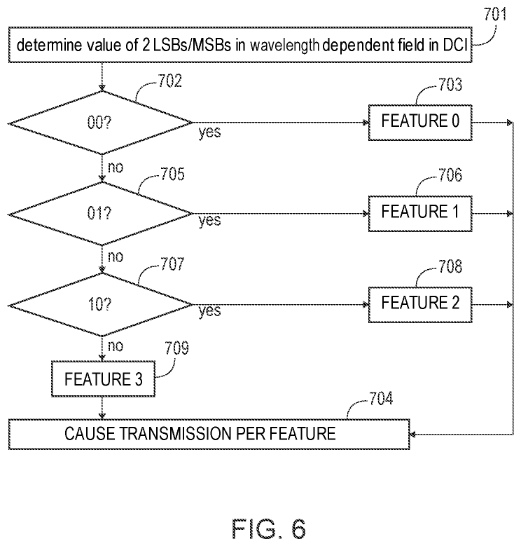

In one embodiment, as further described with respect to FIG. 6, apparatus A, in an instance, the determination indicates one or more bits of a waveform dependent field of the at least one waveform dependent field of the downlink control information (DCI) for scheduling the uplink (UL) transmission are greater than or equal in number to the number of bits, the indication information is indicated by at least one bit of the one or more bits of the waveform dependent field of the at least one waveform dependent field of the downlink control information (DCI) for scheduling the uplink (UL) transmission, the at least one bit being in number the number of bits.

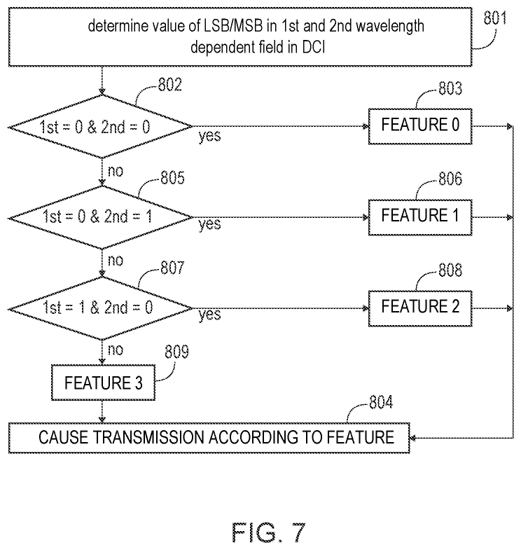

In one embodiment, as further described with respect to FIG. 7, apparatus A, in an instance the determination indicates one or more bits of a waveform dependent field of at least one waveform dependent field of the downlink control information (DCI) for scheduling the uplink (UL) transmission are not greater than or equal in number to the number of bits, makes another determination whether one or more bits of a plurality of waveform dependent fields of the at least one waveform dependent field of the downlink control information (DCI) for scheduling the uplink (UL) transmission are greater than or equal in number to the number of bits (N), the plurality of waveform dependent fields of the at least one waveform dependent field of the downlink control information (DCI) matching the one or more of the at least one waveform dependent field of the list of the at least one list, the list associated with the waveform indicated by the downlink control information (DCI) for scheduling the uplink (UL) transmission; and determines, based on the another determination, the feature of the at least one feature based on another indication information indicated by the one or more bits of the plurality of waveform dependent fields of the at least one waveform dependent field of the downlink control information (DCI) for scheduling the uplink (UL) transmission.

In one embodiment, apparatus A, in an instance the another determination indicates one or more bits of the plurality of waveform dependent fields of the at least one waveform dependent field of the downlink control information (DCI) for scheduling the uplink (UL) transmission are greater than or equal in number to the number of bits, the indication information is indicated by at least one bit of the one or more bits of the plurality of waveform dependent fields of the waveform dependent field of the at least one waveform dependent field of the downlink control information (DCI) for scheduling the uplink (UL) transmission, the at least one bit being in number the number of bits. For example, if there are four candidate waveforms, a combination of two bits can be used to indicate which one of the four candidate waveforms to use.

In one embodiment, apparatus A, in an instance the another determination indicates one or more bits of the plurality of waveform dependent fields of the at least one waveform dependent field of the downlink control information (DCI) for scheduling the uplink (UL) transmission are not greater than or equal in number to the number of bits, the indication information assumes a default value for selecting the feature.

In summary, apparatus A determines (block 530), based on the determination of block 520, the feature as further described in FIG. 6 or FIG. 7, according to a default.

In the illustrated example of FIG. 6 the two bits for determining the feature are either two last significant bits or two most significant bits in a waveform dependent field of a DCI for scheduling the uplink (UL) transmission

In the illustrated example of FIG. 7 the two bits for determining the feature are either a last significant bit of two waveform dependent fields of a DCI for scheduling the uplink (UL) transmission or a most significant bits in a plurality of waveform dependent fields of a DCI for scheduling the uplink (UL) transmission, namely two waveform dependent fields.

As said above, the examples described, especially with FIGS. 4 to 8, are mere non-limiting examples, not covering all possibilities of how a feature may be determined from the described information.

The blocks, related functions, and information exchanges (messages/signals) described above by means of FIGS. 1 to 7 are in no absolute chronological order, and some of them may be performed simultaneously or in an order differing from the given one. Other functions can also be executed between them or within them, and other information may be transmitted, and/or other rules applied. Some of the blocks or part of the blocks or one or more pieces of information can also be left out or replaced by a corresponding block or part of the block or one or more pieces of information. Furthermore, some of the blocks in one example may be combined with another example.

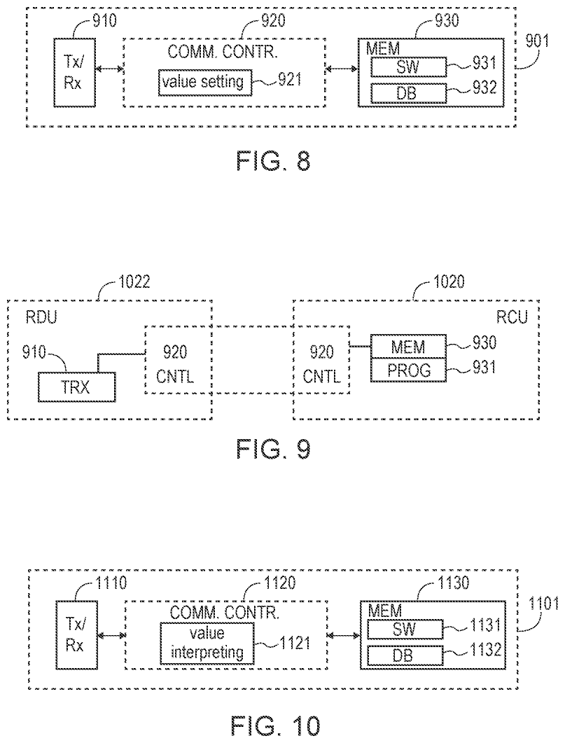

FIG. 8 illustrates an apparatus configured to at least transmit the one or more instructions on how to determine a waveform for at least one uplink transmissions, and to apply then when receiving uplink transmission. FIG. 9 illustrates an apparatus configured to determine, transmit and apply the one or more instructions, and to allocate resources at least for uplink transmissions to the apparatus. In other words, the apparatus of FIG. 9 may implement distributed functionality. FIG. 10 illustrates an apparatus configured to receive the one or more instructions and to apply them to determine a waveform to be used in uplink transmissions from the apparatus. The apparatus 901, 1101 may comprise one or more communication control circuitry 920, 1120 such as at least one processor, and at least one memory 930, 1130 including one or more algorithms 931, 1131, such as a computer program code (software) wherein the at least one memory and the computer program code (software) are configured, with the at least one processor, to cause the apparatus to carry out any one of the exemplified functionalities of the apparatus described above. Said at least one memory 930, 1131 may also comprise at least one database 932, 1132.

Referring to FIG. 8, the one or more communication control circuitry 920 of the apparatus 901 comprise at least value setting circuitry 921 which is configured to perform at least generating downlink control information comprising scheduling information according to embodiments, and possibly the one or more rules, other configuration information and/or time period determining and monitoring, as discussed with FIG. 3. To this end, the waveform determining circuitry 921 of the apparatus 901 is configured to carry out at least some of the functionalities of the apparatus described above, e.g., by means of FIGS. 2 to 7, by the apparatus transmitting downlink, receiving uplink, e.g. the apparatus A, using one or more individual circuitries.

Referring to FIG. 8, the memory 930 may be implemented using any suitable data storage technology, such as semiconductor based memory devices, flash memory, magnetic memory devices and systems, optical memory devices and systems, fixed memory and removable memory.

Referring to FIG. 8, the apparatus 901 may further comprise different interfaces 910 such as one or more communication interfaces (TX/RX) comprising hardware and/or software for realizing communication connectivity according to one or more communication protocols. The one or more communication interfaces 910 may enable connecting to the Internet and/or to a core network of a wireless communications network. The one or more communication interface 910 may provide the apparatus with communication capabilities to communicate in a cellular communication system and enable communication to different network nodes or elements or terminal devices or user equipments, for example. The one or more communication interfaces 910 may comprise standard well-known components such as an amplifier, filter, frequency-converter, (de)modulator, and encoder/decoder circuitries, controlled by the corresponding controlling units, and one or more antennas.

In an embodiment, as shown in FIG. 9, at least some of the functionalities of the apparatus of FIG. 8 may be shared between two physically separate devices, forming one operational entity. Therefore, the apparatus may be seen to depict the operational entity comprising one or more physically separate devices for executing at least some of the described processes. Thus, the apparatus of FIG. 9, utilizing such shared architecture, may comprise a remote control unit RCU 1020, such as a host computer or a server computer, operatively coupled (e.g. via a wireless or wired network) to a remote distributed unit RDU 1022 located in the base station. In an embodiment, at least some of the described processes may be performed by the RCU 1020. In an embodiment, the execution of at least some of the described processes may be shared among the RDU 1022 and the RCU 1020.

Similar to FIG. 8, the apparatus of FIG. 9 may comprise one or more communication control circuitry (CNTL) 920, such as at least one processor, and at least one memory (MEM) 930, including one or more algorithms (PROG) 931, such as a computer program code (software) wherein the at least one memory and the computer program code (software) are configured, with the at least one processor, to cause the apparatus to carry out any one of the exemplified functionalities of the apparatus described above, e.g., by means of FIGS. 2 to 7, by the apparatus transmitting downlink, receiving uplink, e.g. the apparatus A.

In an embodiment, the RCU 1020 may generate a virtual network through which the RCU 1020 communicates with the RDU 1022. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RDU and the RCU. In practice, any digital signal processing task may be performed in either the RDU or the RCU and the boundary where the responsibility is shifted between the RDU and the RCU may be selected according to implementation.

Referring to FIG. 10, the one or more communication control circuitry 1120 of the apparatus 1101 comprise at least a value interpreting circuitry 1121 which is configured to perform determining at least waveform to scheduled uplink transmissions from the apparatus 1101 based on whether to apply a first purpose or a second purpose for at least a predefined bit, and possibly time period determining and monitoring, as discussed with FIG. 3, according to embodiments. To this end, the value interpreting circuitry 1121 of the apparatus 1101 is configured to carry out at least some of the functionalities of the apparatus (uplink transmitting apparatus, e.g. the apparatus B) described above, e.g., by means of FIGS. 2 to 7, using one or more individual circuitries.

Referring to FIG. 10, the memory 1130 may be implemented using any suitable data storage technology, such as semiconductor based memory devices, flash memory, magnetic memory devices and systems, optical memory devices and systems, fixed memory and removable memory.

Referring to FIG. 10, the apparatus 1101 may further comprise different interfaces 1110 such as one or more communication interfaces (TX/RX) comprising hardware and/or software for realizing communication connectivity according to one or more communication protocols. The one or more communication interfaces 1110 may enable connecting to the Internet and/or to a core network of a wireless communications network via an access node, for example. The one or more communication interface 1110 may provide the apparatus with communication capabilities to communicate in a cellular communication system and enable communication to different network nodes or elements. The one or more communication interfaces 1110 may comprise standard well-known components such as an amplifier, filter, frequency-converter, (de)modulator, and encoder/decoder circuitries, controlled by the corresponding controlling units, and one or more antennas.

As used in this application, the term ‘circuitry’ may refer to one or more or all of the following: (a) hardware-only circuit implementations, such as implementations in only analog and/or digital circuitry, and (b) combinations of hardware circuits and software (and/or firmware), such as (as applicable): (i) a combination of analog and/or digital hardware circuit(s) with software/firmware and (ii) any portions of hardware processor(s) with software, including digital signal processor(s), software, and memory(ies) that work together to cause an apparatus, such as a terminal device or an access node, to perform various functions, and (c) hardware circuit(s) and processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including any claims. As a further example, as used in this application, the term ‘circuitry’ also covers an implementation of merely a hardware circuit or processor (or multiple processors) or a portion of a hardware circuit or processor and its (or their) accompanying software and/or firmware. The term ‘circuitry’ also covers, for example and if applicable to the particular claim element, a baseband integrated circuit for an access node or a terminal device or other computing or network device.

In an embodiment, at least some of the processes described in connection with FIGS. 2 to 7 may be carried out by an apparatus comprising corresponding means for carrying out at least some of the described processes, for example means per a block or means per a plurality of blocks. It should be appreciated that any of the apparatuses may be implemented by physically distributed devices forming one logical apparatus. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 2 to 7 or operations thereof.

Embodiments as described may also be carried out in the form of a computer process defined by a computer program or portions thereof. Embodiments of the methods described in connection with FIGS. 2 to 7 may be carried out by executing at least one portion of a computer program comprising corresponding instructions. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. The term “non-transitory,” as used herein, is a limitation of the medium itself (i.e., tangible, not a signal) as opposed to a limitation on data storage persistency (e.g., RAM vs. ROM). Coding of software for carrying out the embodiments as shown and described is well within the scope of a person of ordinary skill in the art.

Even though the embodiments have been described above with reference to examples according to the accompanying drawings, it is clear that the embodiments are not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

Aspects of various embodiments are disclosed in the following numbered items.

1. A method comprising:
determining, at an apparatus, a feature of at least one feature according to a list of at least one list based on:
a number of bits (N),
the at least one list of at least one waveform dependent field,
one or more bits of at least one waveform dependent field of downlink control information (DCI) for scheduling an uplink (UL) transmission,
an indication that dynamic waveform switching (DWS) is utilized of the downlink control information (DCI) for scheduling the uplink (UL) transmission, and
a waveform indicated by the downlink control information (DCI) for scheduling an uplink (UL) transmission; and
causing transmission, at the apparatus, of an UL transmission according to the feature.

2. An apparatus comprising:
at least one processor; and
at least one memory storing instructions that, when executed by the at least one processor, are configured to cause the apparatus at least to perform a plurality of operations, the plurality of operations comprising:
determining a feature of at least one feature according to a list of at least one list based on:
a number of bits (N),
the at least one list of at least one waveform dependent field,
one or more bits of at least one waveform dependent field of downlink control information (DCI) for scheduling an uplink (UL) transmission,
an indication that dynamic waveform switching (DWS) is utilized of the downlink control information (DCI) for scheduling the uplink (UL) transmission, and
a waveform indicated by the downlink control information (DCI) for scheduling an uplink (UL) transmission; and
causing transmission of a UL transmission according to the feature.

3. The apparatus according to claim 2, wherein the determining comprises:
making, based on the indication that dynamic waveform switching (DWS) is utilized being included in the downlink control information (DCI) for scheduling the uplink (UL) transmission, a determination whether the one or more bits of at least one waveform dependent field of the downlink control information (DCI) for scheduling the uplink (UL) transmission are greater than or equal in number to the number of bits (N), the at least one waveform dependent field of the downlink control information (DCI) matching one or more of the at least one waveform dependent field of the list of the at least one list, the list associated with the waveform indicated by the downlink control information (DCI) for scheduling the uplink (UL) transmission; and
determining, based on the determination, the feature of the at least one feature based on indication information indicated by the one or more bits of the at least one waveform dependent field of the downlink control information (DCI) for scheduling the uplink (UL) transmission.

4. The apparatus according to claim 2, wherein the determining the feature of at least one feature according to a list evaluates the list in a sequential order to determine the at least one waveform dependent field of the downlink control information (DCI) matching one or more of the at least one waveform dependent field of the list of the at least one list.

5. The apparatus according to claim 4, wherein the sequential order begins with one of the following:
a first waveform dependent field of the list; and
a last waveform dependent field of the list.

6. The apparatus according to claim 2, wherein the waveform indicated by the downlink control information (DCI) for scheduling the uplink (UL) transmission indicates discrete Fourier transform spread orthogonal frequency division multiplexing.

7. The apparatus according to claim 2, wherein the one or more bits in the at least one waveform dependent field of the downlink control information (DCI) for scheduling the uplink (UL) transmission comprise one or more padded bits in the at least one waveform dependent field of the downlink control information (DCI) for scheduling the uplink (UL) transmission.

8. The apparatus according to claim 2, wherein the determining is further based on indication information indicated by the one or more bits of the at least one waveform dependent field of the downlink control information (DCI) for scheduling the uplink (UL) transmission.

9. The apparatus according to claim 2, wherein the determining the feature of at least one feature associated with a list is further based on indication information comprising a value indicated by the one or more bits of the at least one waveform dependent field of the downlink control information (DCI) for scheduling the uplink (UL) transmission.

10. The apparatus according to claim 2, wherein the determining the feature of at least one feature associated with a list is further based on a position in the at least one waveform dependent field of the downlink control information (DCI) for scheduling the uplink (UL) transmission of the one or more bits of the at least one waveform dependent field of the downlink control information (DCI) for scheduling the uplink (UL) transmission.

11. The apparatus according to claim 2, wherein the one or more bits in the at least one waveform dependent field of the downlink control information (DCI) for scheduling the uplink (UL) transmission comprise one of the following:
one or more most significant bits in the at least one waveform dependent field of the downlink control information (DCI) for scheduling the uplink (UL) transmission, and
one or more least significant bits in the at least one waveform dependent field of the downlink control information (DCI) for scheduling the uplink (UL) transmission.

12. The apparatus according to claim 2, wherein the at least one list of the at least one waveform dependent field identifies one or more bits of the at least one waveform dependent field of the at least list.

13. The apparatus according to claim 2, wherein the at least one waveform dependent field of the downlink control information (DCI) is in the at least one list of the at least one waveform dependent field.

14. The apparatus according to claim 2, wherein the at least one processor and the at least one memory storing instructions that, when executed by the at least one processor, are further configured to:
receive the downlink control information (DCI) for scheduling the uplink (UL) transmission, wherein the downlink control information (DCI) for scheduling the uplink (UL) transmission comprises the indication that dynamic waveform switching (DWS) is utilized and the indication information indicated by the one or more bits of the at least one waveform dependent field of the second downlink control information (DCI), and the waveform indicated by the downlink control information (DCI) for scheduling an uplink (UL) transmission.

15. The apparatus according to claim 2, wherein the uplink (UL) transmission comprises a physical uplink control channel (PUSCH) transmission.

16. The apparatus according to claim 2, wherein the at least one processor and the at least one memory storing instructions that, when executed by the at least one processor, are further configured to determine the number of bits and the at least one list of the at least one waveform dependent field.

17. The apparatus according to claim 2, wherein the at least one processor and the at least one memory storing instructions that, when executed by the at least one processor, are further configured to determine an indication on whether dynamic waveform switching is applied or not applied.

18. The apparatus according to claim 2, wherein the at least one processor and the at least one memory storing instructions that, when executed by the at least one processor, are further configured to determine, via at least one of the following:
radio resource control (RRC) configuration, and
other downlink control information (DCI), at least one of following:
the number of bits, and
the at least one list of at least one waveform dependent.

19. The apparatus according to claim 2, wherein the at least one processor and the at least one memory storing instructions that, when executed by the at least one processor, are further configured to:
determine the number of bits (N) and the at least one list of the at least one waveform dependent field for the downlink control information (DCI), the downlink control information (DCI) for scheduling the uplink (UL) transmission, wherein the one or more bits of the at least one waveform dependent field of the downlink control information (DCI) are to be used for indicating the feature of at least one feature when the downlink control information (DCI) indicates dynamic waveform switching (DWS) is utilized, wherein the at least one waveform dependent field of the downlink control information (DCI) is identified in list of the at least one list of the at least one waveform dependent field.

20. An apparatus comprising:
at least one processor; and
at least one memory storing instructions that, when executed by the at least one processor, are configured to cause the apparatus at least to perform a plurality of operations, the plurality of operations comprising:
causing transmission of a downlink control information (DCI) for scheduling an uplink (UL) transmission, wherein the downlink control information (DCI) for scheduling the uplink (UL) transmission comprises an indication that dynamic waveform switching (DWS) is utilized, an indication that indicates a waveform and information according to one or more bits of at least one waveform dependent field of the downlink control information (DCI) for scheduling information;
receiving an uplink transmission according to a feature of at least one feature; and
determining a feature of the at least one feature according to a list of at least one list based on:
a number of bits (N),
at least one list of at least one waveform dependent field,
one or more bits of the at least one waveform dependent field of downlink control information (DCI) for scheduling the uplink (UL) transmission,
the indication that dynamic waveform switching (DWS) is utilized of the downlink control information (DCI) for scheduling the uplink (UL) transmission, and
the waveform indicated by the downlink control information (DCI) for scheduling an uplink (UL) transmission.
